(19) United States
(12) Patent Application Publication
(10) Pub. No.: US 2013/0112824 A1
(43) Pub. Date: May 9, 2013

(54) Structure for placing electronic device

(71) Applicant: TENNRICH INTERNATIONAL CORP., Taoyuan Hsieh (TW)

(72) Inventors: SHIH-HUI CHEN, Taoyuan Hsieh (TW); CHIN-TIEN LIN, Taoyuan Hsieh (TW); HUA-CHI CHENG, Taoyuan Hsieh (TW)

(73) Assignee: TENNRICH INTERNATIONAL CORP., Taoyuan Hsieh (TW)

(21) Appl. No.: 13/667,173

(22) Filed: Nov. 2, 2012

(30) Foreign Application Priority Data
Nov. 4, 2011 (TW) 100220913

(51) Int. Cl. F16B 47/00

(52) U.S. Cl. CPC F16B 47/00
USPC 248/206.2

(57) ABSTRACT

A placing structure is disposed with a main body made of a flexible material and at least one sucking component. The main body is disposed with at least one through hole. Each sucking component can selectively pass through the through hole to fasten on the main body. At least one electronic device can be combined with a power bank through the sucking component, and the electrical connection is formed. Alternatively, at least one expansion module is combined with the electronic device, and the electrical connection is formed to reduce carry volume and increase practicality.

### BACKGROUND OF THE INVENTION

1. Field of the Invention

The invention related to an improved placing structure, and more particularly to an improved placing structure applied in charging electronic device or expanding function and having the efficacy of convenient carrying.

2. Description of the Related Art

The development of electrical technology widely applies consumer electronic products in people daily life at very high speed. For example, small sized electronic products, such as mobile phones, digital cameras, PDAs, laptop computers or MP3 Walkman and the like, must be made to achieve slim and light weight but also must achieve portable by carrying batteries. Moreover, to satisfy the requirement of environmental protection, foregoing products have been equipped with chargeable batteries. These chargeable batteries normally include Nickel-cadmium batteries, Nickel-hydrogen batteries and lithium batteries. The chargeable batteries usually need a charging device to charge the appliances.

With reference to FIG. 1, a conventional chargeable device mainly includes a charging holder 11 and a battery 12. The charging holder 11 is disposed a charging circuit 13 therein. The charging circuit 13 is connected to a plug 14 and an output terminal 15. The plug 14 and the output terminal 15 are disposed at the exterior of the charging holder 11. The battery 12 is disposed inside an electronic product 16. The battery 12 is connected to an input terminal 17. The input terminal 17 is disposed to an exterior of the electronic product 16.

According to the foregoing structure, the plug 14 of the conventional chargeable device is inserted in a socket capable of supplying power source such that alternating current of the socket flows through the charging circuit 13. The charging circuit 13 converts alternating current into direct current and introduces direct current into the output terminal 15. When the power of the battery 16 inside the electronic product 16 is exhausted, the output terminal 15 is connected to the input terminal 17 of the electronic product 16. Direct current flows through the battery 12 through the output terminal 15 connected to the input terminal 17 so as to charge the battery 12.

The chargeable device of power supplied by the supply mains or the portable chargeable device (e.g. a power bank) is separated from the electronic product since both are two respective individualities. The foregoing device may not have enough carry convenience.

### SUMMARY OF THE INVENTION

It is a primary objective of the present invention to provide an improved placing structure for use in charging an electronic device or expanding functions and having effect of carry convenience.

The placing structure is disposed with a main body made of flexible material and at least one sucking component. The main body is disposed with at least one through hole. The through hole can pass through two corresponding surfaces of the main body. The sucking component is disposed with a fastening portion and sucking portions extended from two sides of the fastening portion. The sucking component can be fastened in the through hole through the fastening portion. The sucking portions at two sides can respectively appear two corresponding surfaces of the main body.

The sucking component of the invention is mobility. The sucking component can be fastened to the through hole at the specific position based upon demands. Further, at least an electronic device is combined with a power bank, and an electrical connection is formed. Alternatively, at least an expansion module is combined with the electronic device, and the electrical connection is formed to reduce the carry volume and increase the practicality. The through hole that is not disposed with the sucking component can also be taken as the function of heat dissipation.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is a block diagram of a conventional charging device;

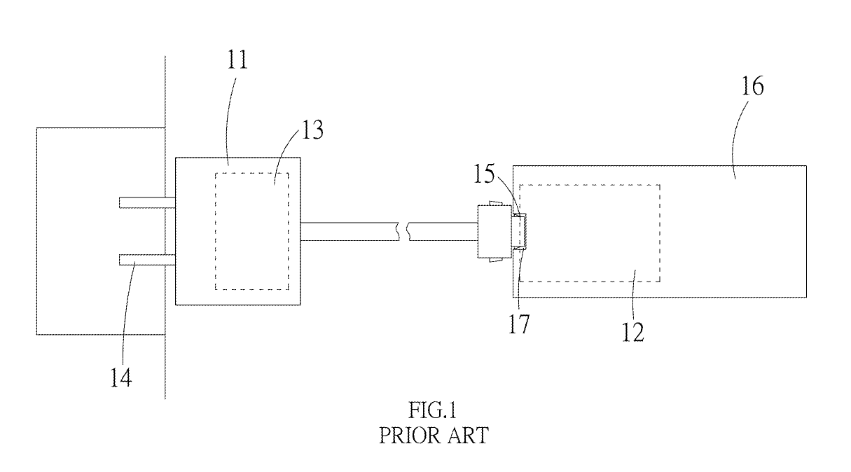

FIG. 2 is a structural stereo diagram of a placing structure according to an invention;

FIG. 3 is a structural schematic diagram of a placing structure according to an invention;

FIG. 4 is a schematic diagram of using the placing structure according to a first embodiment of the invention;

FIG. 5 is a stereo diagram of using the placing structure according to a second embodiment of the invention; and

FIG. 6 is a structural stereo diagram of using the placing structure according to a third embodiment of the invention.

### DETAILED DESCRIPTION OF THE PREFERRED EMBODIMENTS

The technical content of the present invention will become apparent by the detailed description of the following embodiments and the illustration of related drawings as follows.

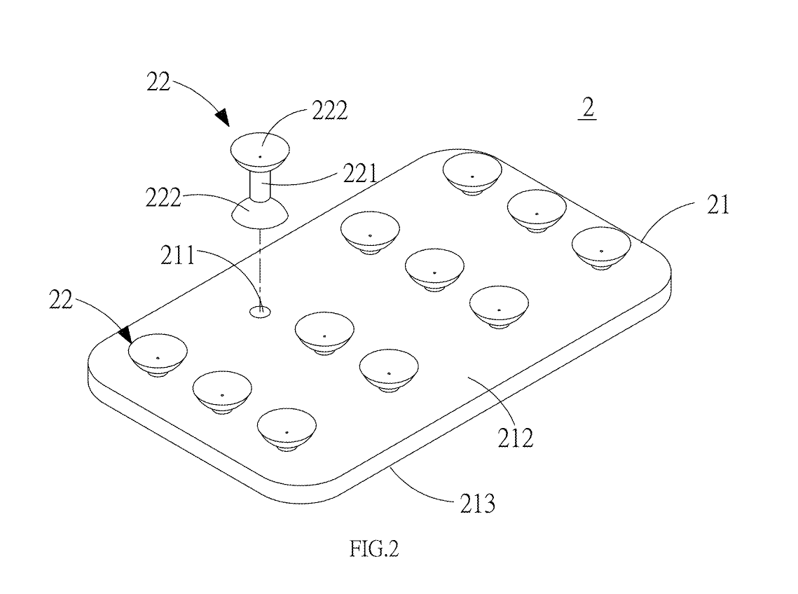

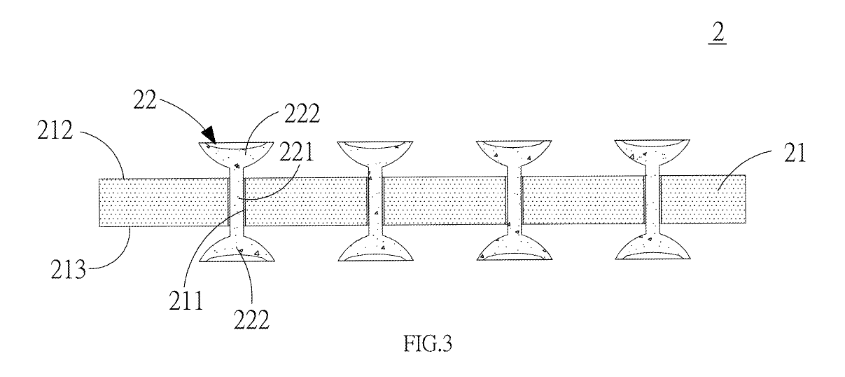

The improved structure for placing electronic device of the invention is shown in FIG. 2 and FIG. 3. The placing structure 2 is disposed with a main body 21 made of a flexible material and at least one sucking component 22. The flexible material can be rubber, polyurethane (PU), acrylic series or modified elastomer materials. The main body 21 is disposed with at least one through hole 211. The through hole 211 can penetrate through two corresponding surfaces 212, 213 of the main body 21. The sucking component 22 is disposed with a fastening portion 221 and sucking portions 222 extended from two sides of the fastening portion 221. The sucking component 22 is fastened in the through hole 211 through the fastening portion 221. The sucking portions 222 at two sides respectively appear the two corresponding surfaces 212, 213.

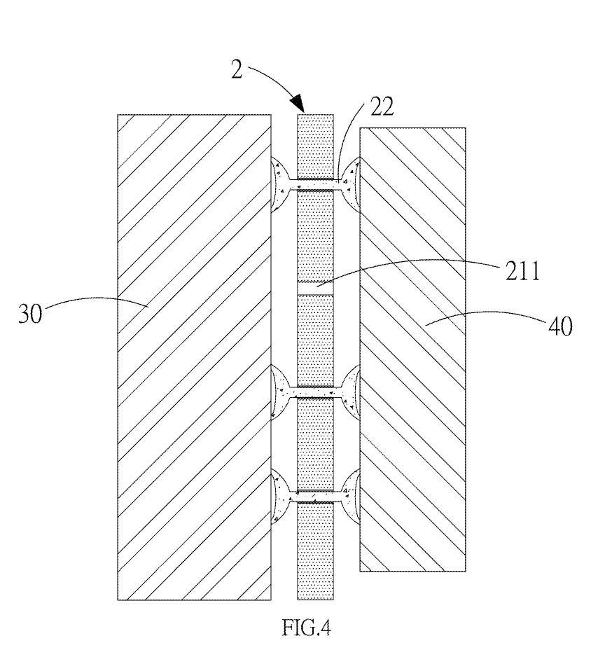

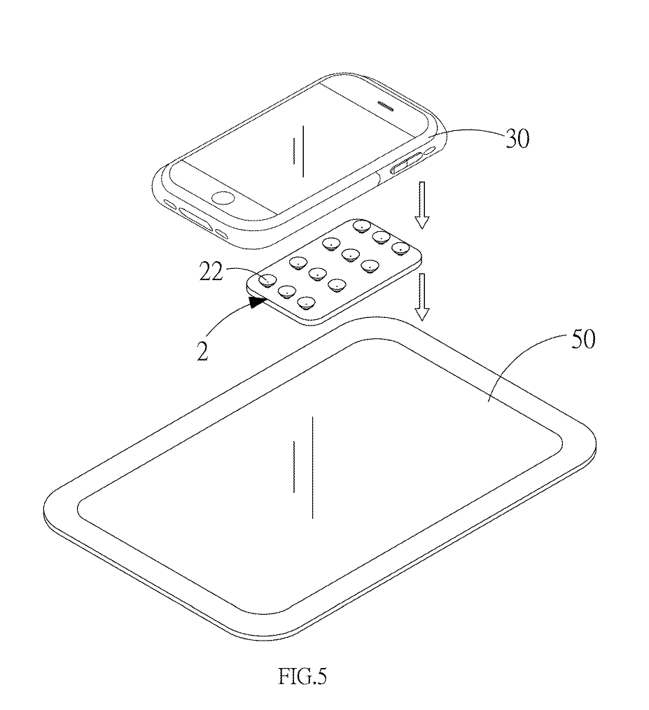

The placing structure of the invention can be applied in charging the electronic device or applied in expanding the function of the electronic device. The placing structure combines at least one electronic device 30 (it can be a hand-held electronic device, such as a mobile phone or a personal digital assistant, PDA and the like, or a laptop computer) with the power bank 40 as shown in FIG. 4 and can utilize a transmission component (not shown in the figure) to form power transmission between the electronic device 30 and the power bank 40. Alternatively, at least one expansion module 50 is combined with the electronic device 30 as shown in FIG. 5. The expansion module 50 forms electrical connection through the transmission component (not shown in the figure) inserted into the electronic device 40 such that the electronic device 30 does not only have original function but also increases the functions, such as satellite positioning function, recording function, digital video playing function, wireless communication function, broadcast signal transmission/receiving function, and the like, provided by the expansion module 50.

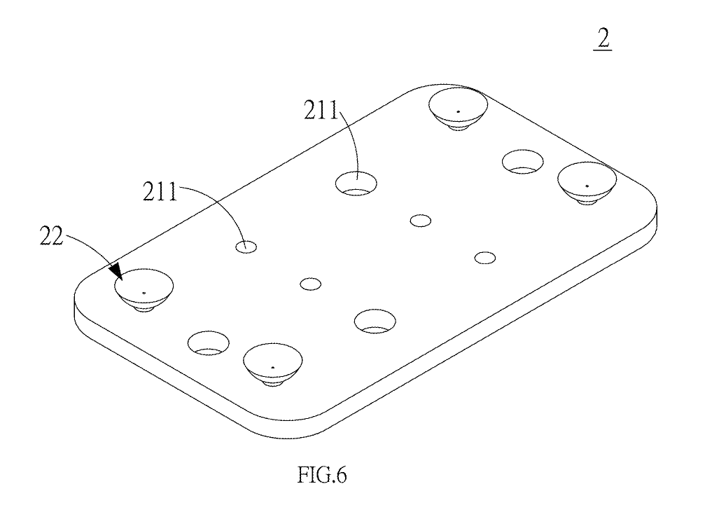

Of course, the user can select the number and location of disposing the sucking component 22 on the main body as shown in FIG. 6 to allow the whole placing structure having more flexibility and providing practicality. Further, the through hole 211 that is not disposed with the sucking component 22 can also be taken as the purpose of heat dissipation. Please refer to

FIG. 4, and moreover the main body can be disposed with through holes having different sizes. The surface connection place between the through hole and the main body can form a chamfer (not shown in the figure). The chamfer can be an arc shape that is conveniently detach and mount the sucking component. In addition, fluorescent particles can be added in the main body to have marking effect at night or in the dark environment.

It should be noted that the main body of the placing structure of the invention and the sucking component are integrally modeled. The whole formation step is simpler, and the flexible material can form any shape to mount different kinds of articles. The structure can be applied in charging the electronic device or expanding functions to reduce carry volume and increase the practicality. Further, the through holes disposed on the main body can be taken as the function of heat dissipation.

While the means of specific embodiments in the placing structure for the electronic device provided by the present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A structure for placing an electronic device, comprising:
a main body made of a flexible material, the main body disposed with at least one through hole, the through hole capable of passing through two corresponding surfaces of the main body; and
at least a sucking component made of a flexible material, the sucking component disposed with a fastening portion and sucking portions extended from two sides of the fastening portion, the sucking component fastened in the through hole through the fastening portion, the sucking portions at two sides respectively appearing the two corresponding surfaces of the main body.

2. The structure for placing an electronic device of claim 1, wherein a surface connection place between the through hole and the main body is formed with a chamfer.

3. The structure for placing an electronic device of claim 2, wherein the chamfer is an arc shape.

4. The structure for placing an electronic device of claim 1, wherein fluorescent particles are added in the main body.

5. The structure for placing an electronic device of claim 1, wherein the structure combines at least one electronic device with a power bank.

6. The structure for placing an electronic device of claim 1, wherein the structure combines at least one expansion module with the electronic device.
